(19) United States
(12) Patent Application Publication
(10) Pub. No.: US 2020/0151676 A1
(43) Pub. Date: May 14, 2020

(54) ISSUE TRACKING AND RECTIFICATION SYSTEM AND METHOD

(71) Applicant: ICHASE Safety Solution Pty Ltd, Bulimba, Brisbane, Queensland (AU)

(72) Inventor: Graeme Mitchell, Brisbane (AU)

(21) Appl. No.: 16/479,781

(22) PCT Filed: Jan. 22, 2018
(86) PCT No.: PCT/AU2018/050039

§ 371 Date: Jul. 22, 2019

(30) Foreign Application Priority Data
Jan. 23, 2017 (AU) 2017900193

(51) Int. Cl. G06Q 10/00; G06Q 10/06; H04W 4/029

(52) U.S. Cl. CPC G06Q 10/20; G06Q 10/063112; H04W 4/029; G06Q 10/06316; G06Q 10/06315

(57) ABSTRACT

An issue tracking and rectification system includes a workflow server; a workflow database connected to the workflow server; and a first mobile electronic device connected to the workflow server via a network, wherein the first electronic device is configured to capture an image of a task subject, determine a location of the task subject and generate an issue log using the image and location, and further wherein the first electronic device is configured to generate a work order from the issue log and transmit the work order to the workflow server over the network, whereby the workflow server commences a workflow to attend to the task subject.

### FIELD OF INVENTION

The present invention relates to issue tracking and rectification systems and methods. The present invention has particular but not exclusive application in the detection and rectification of rail hazards.

### BACKGROUND OF THE INVENTION

During an ordinary work day of a worker, for example a rail worker, hazards present themselves regularly and need to be mitigated in order for the worker to safely carry out their work. Such hazards range from minor inconveniences to life threatening events.

Manual issue tracking and rectification systems are still common practice in many industries. These manual systems are prone to error, loss, or destruction. Additionally, crucial safety recommendations, feedback, failures, and incidents are not properly reported and recorded, resulting in an increase potential for safety incidents occurring repeatedly.

For example, when executing maintenance and repair tasks in the rail industry, best practices for carrying out the tasks are often unknown, or not fully known, by the work crew. Advice on how to perform a task is often obtained from books, written documentation, or ad hoc advice from others. This is time consuming, frustrating, and prone to obsolescence, error, misinterpretation and/or miscommunication. Accordingly, the task being performed may be executed incorrectly, leading to the task not being performed properly, the task not being performed efficiently, and/or the task being performed in an unsafe manner.

While reference material and Safe Work Method Statements (SWMS) for a specific task are, in theory, meant to be available to the work crews performing the tasks, in practice such documents are often not obtained, not provided, or non-existent, due to the inconveniences and limitations of working with a manual system.

### OBJECT OF THE INVENTION

It is one object of the present invention to provide a system and method that allows for maintenance and repair tasks to be readily identified, logged, and performed, and for such tasks to be performed safely, efficiently, and in accordance with best practice, whereby the risks of safety incidents occurring is reduced.

It is a further object of the present invention to provide a system and method for keeping reference material, SWMS, best practice instructions, and the like up to date and readily available to work crews.

It is still a further object of the present invention to predict and pre-empt maintenance and repair tasks using historical records of identified and logged tasks.

This and other objects of the present invention will be made apparent from the following disclosure of the invention.

### SUMMARY OF THE INVENTION

According to a first aspect of the present invention, an issue tracking and rectification system comprises a workflow server; a workflow database connected to the workflow server; and a first mobile electronic device connected to the workflow server via a network, wherein the first electronic device is configured to capture an image of a task subject, determine a location of the task subject and generate an issue log using the image and location, and further wherein the first electronic device is configured to generate a work order from the issue log and transmit the work order to the workflow server over the network, whereby the workflow server commences a workflow to attend to the task subject.

In one form, the workflow server identifies and retrieves from the workflow database a task description for the work order, the task description setting out at least the resources, required for the safe and proper execution of the work order.

Preferably, the task description further sets out one or more of the method, tasks, sub-tasks, and skills required for the safe and proper execution of the work order.

Preferably, the task description further sets out a risk assessment for the execution of the work order.

In one form, the workflow server determines from the task description a list of resources and personnel skills and experiences required for the execution of the work order.

In one form, the workflow server retrieves from the workflow database and/or other external databases a location description, the location description setting out one or more characteristics of the task subject location.

Preferably, the one or more characteristics set out by the location description include a current weather conditions, forecasted weather conditions, weather patterns, seasonal patterns, weather-associated risks, geographical features and associated risks, indigenous significance, environmental constraints, and environmental sensitivities. Preferably the one or more characteristics set out by the location description includes underground and/or underwater infrastructure, such as pipes, tunnels, trenches, cables, moorings, and/or the like. Preferably the one or more characteristics set out by the location description includes underground and/or underwater obstructions, such as refuse, rocks, caves, caverns, underground waterways, roots, live ordnances, and/or the like. In one form, the one or more characteristics set out by the location description includes contact details for an entity that is responsible for the underground and/or underwater infrastructure or obstruction.

In one form, the first electronic device is configured to transmit one or more characteristics to the workflow server over the network to be included in the location description. In one embodiment, the first electronic device is configured to transmit a location of newly installed underground and/or underwater infrastructure to the workflow server to be included in the location description. In another embodiment, the first electronic device is configured to transmit a location of discovered underground and/or underground infrastructure or objects to the workflow server to be included in the location description. In a further embodiment, the first electronic device is configured to transmit a corrected location of known underground and/or underwater infrastructure or objects to the workflow server to be included in the location description.

In one form, the first electronic device is configured to transmit a plan to the workflow server to be included in the location description. In one form the plan is an updated plan or a new plan. In one form, the workflow server saves the updated or new plan to the workflow database and/or other external databases. Preferably the workflow server maintains an archive of previous plans in the workflow database and/or other external databases.

In one form, the first electronic device is configured to transmit one or more characteristics of an object or an obstruction located at the location of the task subject to the work flow server. Preferably the one or more characteristics includes one or more pictures of the object or obstruction. Preferably the work flow server associates an alert with the location of the task subject in response to receiving one or more characteristics of an object or an obstruction located at the location. In one embodiment, the object can be an item of equipment. In another embodiment, the obstruction can be an environmental obstruction such as a washaway.

In one form, the workflow server retrieves from the workflow database a priority description, the priority description stipulating additional considerations, constraints, communications and other actions to be taken for a given priority status of a work order. In one form, the priority description can include an alert associated with the location of the task subject.

In one form, the first electronic device is configured to transmit one a unique identifier to the work flow server. Preferably the unique identifier is associated with any information transmitted to the work flow server from the first electronic device to identify the source of the information.

In one form, the workflow server analyses each of the task description, location description, and priority description, and generates a work plan therefrom.

Preferably, the analysis performed by the workflow server includes a confirmation with a storage centre to ascertain and confirm availability of resources at the storage centre.

Preferably, the analysis performed by the workflow server includes a confirmation with a vehicle centre to ascertain and confirm availability of vehicles at the vehicle centre.

Preferably, the analysis performed by the workflow server includes a search for personnel with the required skills and experience to comprise a work crew to attend to the tasks required by the work order.

In one form, the workflow server generates a work plan, the work plan detailing one or more of required resources, locations of required resources, route to collect required resources, personnel comprising work crew, tasks to be performed, and schedule/timing of tasks.

Preferably, the workflow server transmits the work plan to a plurality of second electronic devices, each of the plurality of second electronic devices being operated by personnel comprising the work crew.

In one form, the work plan and other reference material is made available to personnel comprising the work crew during performance of the tasks by way of the second electronic devices.

In one form, each of the plurality of second electronic devices configured to transmit one or more characteristics to the workflow server over the network to be included in the location description.

In one form, at least one of the second electronic devices is configured to receive, from a member of the work crew, information for the generation of a Post Action Report (PAR), the PAR including feedback on the execution of the work plan, wherein the at least one second electronic device is operated to generate the PAR from the received information.

In one form, the second electronic device transmits the PAR to the workflow server.

In one form, following review of the PAR, the workflow server updates one or more pieces of reference material in the workflow database in accordance with the result of the review.

In one form, the workflow server analyses logged issues stored in the workflow database, and schedules periodic maintenance based thereon.

In one form, the workflow server analyses logged issues stored in the workflow database, and schedules pre-emptive maintenance based thereon.

In one form, the issue tracking and rectification system is used to conduct maintenance in an amusement park.

According to a second aspect of the present invention, an issue tracking and rectification method comprises a first electronic device capturing an image of a task subject, the first electronic device determining a location of the task subject, the first electronic device generating an issue log from the captured image and the determined location, the first electronic device generating a work order from the issue log, and the first electronic device transmitting the work order to a workflow server over a network, wherein upon receipt of the work order, the workflow server commences a workflow to attend to the task subject.

In one form, the method further comprises the workflow server identifying and retrieving from the workflow database a task description for the work order, the task description setting out at least the resources, required for the safe and proper execution of the work order.

Preferably, the task description further sets out one or more of the method, tasks, sub-tasks, and skills required for the safe and proper execution of the work order.

Preferably, the task description further sets out a risk assessment for the execution of the work order.

In one form, the method further comprises the workflow server determining from the task description a list of resources and personnel skills and experiences required for the execution of the work order.

In one form, the method further comprises the workflow server retrieving from the workflow database and/or other external databases a location description, the location description setting out one or more characteristics of the task subject location.

Preferably, the one or more characteristics set out by the location description include current weather conditions, forecasted weather conditions, weather patterns, seasonal patterns, weather-associated risks, geographical features and associated risks, indigenous significance, environmental constraints, and environmental sensitivities.

In one form, the method further comprises the first electronic device transmitting one or more characteristics to the workflow server over the network to be included in the location description.

In one form, the method further comprises the workflow server retrieving from the workflow database a priority description, the priority description stipulating additional considerations, constraints, communications and other actions to be taken for a given priority status of a work order.

In one form, the method further comprises the workflow server analysing each of the task description, location description, and priority description, and generating a work plan therefrom.

Preferably, the analysis performed by the workflow server includes the workflow server confirming with a storage centre an availability of resources at the storage centre.

Preferably, the analysis performed by the workflow server includes the workflow server confirming with a vehicle centre an availability of vehicles at the vehicle centre.

Preferably, the analysis performed by the workflow server includes the workflow server searching for personnel with the required skills and experience to comprise a work crew to attend to the tasks required by the work order.

In one form, the method further comprises the workflow server generating a work plan, the work plan detailing one or more of required resources, locations of required resources, route to collect required resources, personnel comprising work crew, tasks to be performed, and schedule/timing of tasks.

Preferably, the workflow server transmits the work plan to a plurality of second electronic devices, each of the plurality of second electronic devices being operated by personnel comprising the work crew.

In one form, the method further comprises at least one of the plurality of second electronic devices transmitting one or more characteristics to the workflow server over the network to be included in the location description.

In one form, the method further comprises the workflow server making the work plan and other reference material available to personnel comprising the work crew during performance of the tasks by way of the second electronic devices.

In one form, the method further comprises at least one of the second electronic devices receiving, from a member of the work crew, information for the generation of a Post Action Report (PAR), the PAR including feedback on the execution of the work plan, and the at least one second electronic device generating the PAR.

In one form, the method further comprises the second electronic device transmitting the PAR to the workflow server.

In one form, following review of the PAR, the method further comprises the workflow server updating one or more pieces of reference material in the workflow database in accordance with the result of the review.

In one form, the method further comprises the workflow server analysing logged issues stored in the workflow database, and scheduling periodic maintenance based thereon.

In one form, the method further comprises the workflow server analysing logged issues stored in the workflow database, and scheduling pre-emptive maintenance based thereon.

In one form, the issue tracking and rectification method is an issue tracking and rectification method for conducting maintenance in amusement parks.

The above aspects, variations, and options are to be understood as comprisable within the invention singly, or in combination with each other.

### BRIEF DESCRIPTION OF THE DRAWINGS

In order that the present invention can be more readily understood, reference will now be made to the accompanying drawings which illustrate preferred embodiments of the invention and wherein:

FIG. 1 illustrates an issue tracking and rectification system according to the present invention;

FIG. 2 illustrates an operation and method for generating a work order according to the present invention;

FIG. 3 illustrates an operation and method for executing a work order, and generating and executing a corresponding work plan; and

FIG. 4 illustrates an operation and method for generating and actioning a Post Action Report (PAR).

### DETAILED DESCRIPTION OF PREFERRED EMBODIMENTS

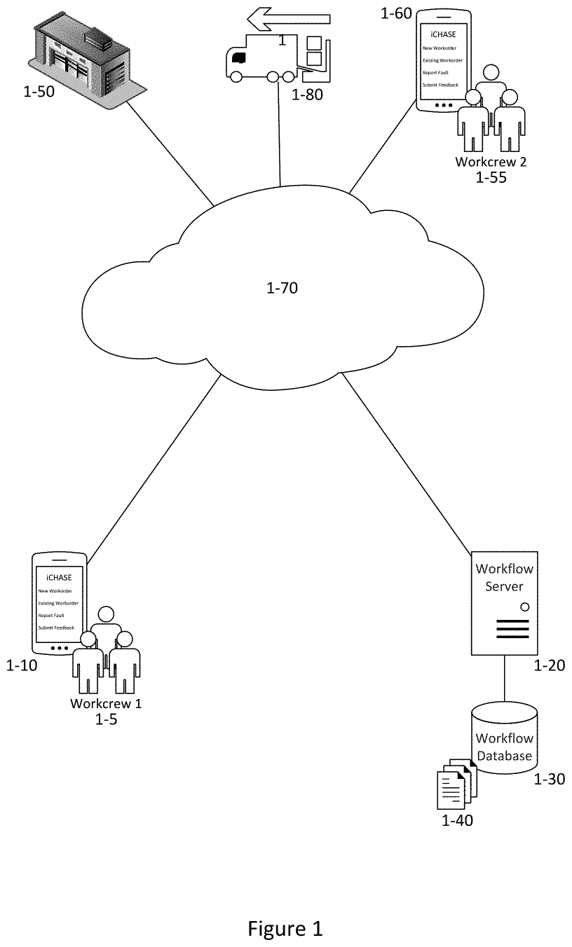

FIG. 1 illustrates an issue tracking and rectification system 100 according to the present invention. The system 100 includes a first electronic device 1-10 connected via a network 1-70 to a workflow server 1-20 and a workflow database 1-30. In a preferred embodiment, the system 100 further includes a second electronic device 1-60, a storage centre 1-50, and a vehicle centre 1-80, each of which are connected via the network 1-70 to the workflow server 1-20. Additional centres, operation hubs, and the like may also be included in the system 100.

Each of the components of the system 100 will now be described in greater detail.

The first and second electronic devices 1-10, 1-60 are portable electronic computing devices, such as a smartphone, laptop, smart glasses, and the like. In the preferred embodiment, the electronic devices 1-10, 1-60 execute therein a software application configured to connect the electronic devices 1-10, 1-60 to the server 1-20 and to interact therewith. Alternatively, the electronic devices 1-10, 1-60 connect to and interact with the server 1-20 through a web browser executing on the electronic devices 1-10, 1-60.

The electronic devices 1-10, 1-60, when executing the software application, are configured by the software application to perform one or more of the following functions:
Report a fault or other issue
Generate a work order
Transmit a work order
Receive a work plan
Execute a work plan
Conduct a Post Action Review (PAR)
Determine and report on the location of the electronic device
Identify an operator of electronic device

The workflow server 1-20 is a network accessible server system configured to configure, coordinate, instruct, and/or otherwise manage the system 100 and its components 1-10, 1-30, 1-50, 1-60, 1-80. The workflow server 1-20, as will be described in greater detail below, is configured in particular to generate and issue work plans based on a variety of inputs. Additionally, the workflow server 1-20 manages access to the workflow database 1-30 and reference material 1-40 stored therein. As required, the workflow server 1-20 further performs the function of a database server, web server, network server, cloud server, VPN server, and any other function necessary to effect the system 100.

The workflow server 1-20 in particular is configured to perform the following functions:
Analyse/process information from electronic devices 1-10, 1-60
Analyse/process information from storage centre 1-50
Analyse/process information from vehicle centre 1-80
Analyse/process information from external sources
Generate work plans
Analyse historical work orders
Predict and/or pre-empt future faults and work orders

Whilst the workflow server 1-20 is illustrated in FIG. 1 as a single server device, it is to be understood that the workflow server 1-20 is not so limited. The workflow server 1-20, as previously alluded too, may be comprised of a number of other servers (either logically or physically) and/or have a distributed and/or cloud-based arrangement.

The workflow database 1-30 stores therein task relevant reference material for use in executing a work order, generating a work plan, executing a work plan, and/or performing tasks and sub-tasks specified by a work order and/or work plan. The types of reference materials stored in the workflow database 1-30 include, but are not limited to, task instructions (e.g. how to fix a broken rail), equipment operating guides (e.g. how to operate a rail welder), risk management requirements (e.g. Safe Work Method Statements, SWMS, also known as How to Safely or H2S statements), Material Safety Data Sheets (MSDS), rest-work cycles, first aid instructions, maps, weather forecasts and historical records, blueprints, circuit diagrams, design drawings, schematics, underground infrastructure (e.g. buried cables, pipes, tunnels and other buried objects) and personnel profiles (e.g. experience/skills of crew members). Where appropriate, the database 1-30 characterises the reference material stored therein by one or more characteristics, such as environmental factors (e.g. high heat, remote location, location of indigenous cultural significance, underground), operational risks (e.g. crush risks, fumes, height), and the like so as to facilitate search and identification functions.

The storage centre 1-50 is, for example, a warehouse or distribution centre that stores or centralizes therein equipment and other resources required for the execution of work orders, work plans, and tasks. In the preferred embodiment, electronic inventories of existing equipment and resources are maintained by the storage centre 1-50, which electronic inventories are made available to the workflow server 1-20 over the network 1-70.

The vehicle centre 1-80 is, for example, a vehicle yard and/or a fleet depot. The vehicle centre 1-80 maintains a record of each vehicle managed by the vehicle centre 1-80, including a capability, a status, and a current location of each vehicle. The record is made available to the workflow server 1-20 over the network 1-70.

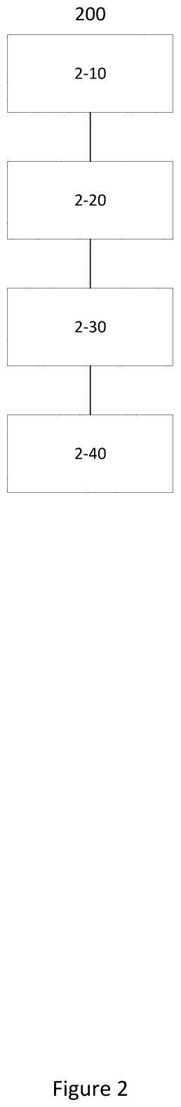

With reference now to FIG. 2, a method 200 for recording and commencing a maintenance and repair task is described.

The method 200 commences at 2-10, where the first electronic device 1-10 is configured and operated by the software application and used to capture an image of an identified fault, hazard, or other item (hereinafter referred to as a “task subject”) that requires maintenance and/or repair. Additionally, a location of the task subject is determined by the first electronic device 1-10, using for example a GPS sensor or other similar positioning system. From the captured image and location, and additional information including date, time, and user's ID, the first electronic device 1-10 generates an issue log.

At 2-20, further details of the task subject are received from the user and added to the issue log by the first electronic device 1-10. The further details include, but are not limited to, one or more of:
Nature of the fault
Size of the fault
Impact of the fault
Likely cause of the fault
Fault rectification solution
Other comments

At 2-30, a priority of the fault is received from the user and added to the issue log by the first electronic device 1-10.

At 2-40, the first electronic device 1-10 generates a work order from the information provided in steps 2-10, 2-20, and 2-30. The generated work order is transmitted by the first electronic device 1-10 over the network 1-70 to the work flow server 1-20.

As will be described in detail below, the generation of the work order by the first electronic device 1-10 commences a workflow that ultimately results in the task subject being maintained and/or repaired and/or attended to as required, and the procedure, reference material, and any other processes and information used in the execution of the work order, analysed and updated in the workflow database 1-30 by the workflow server 1-20 as necessary.

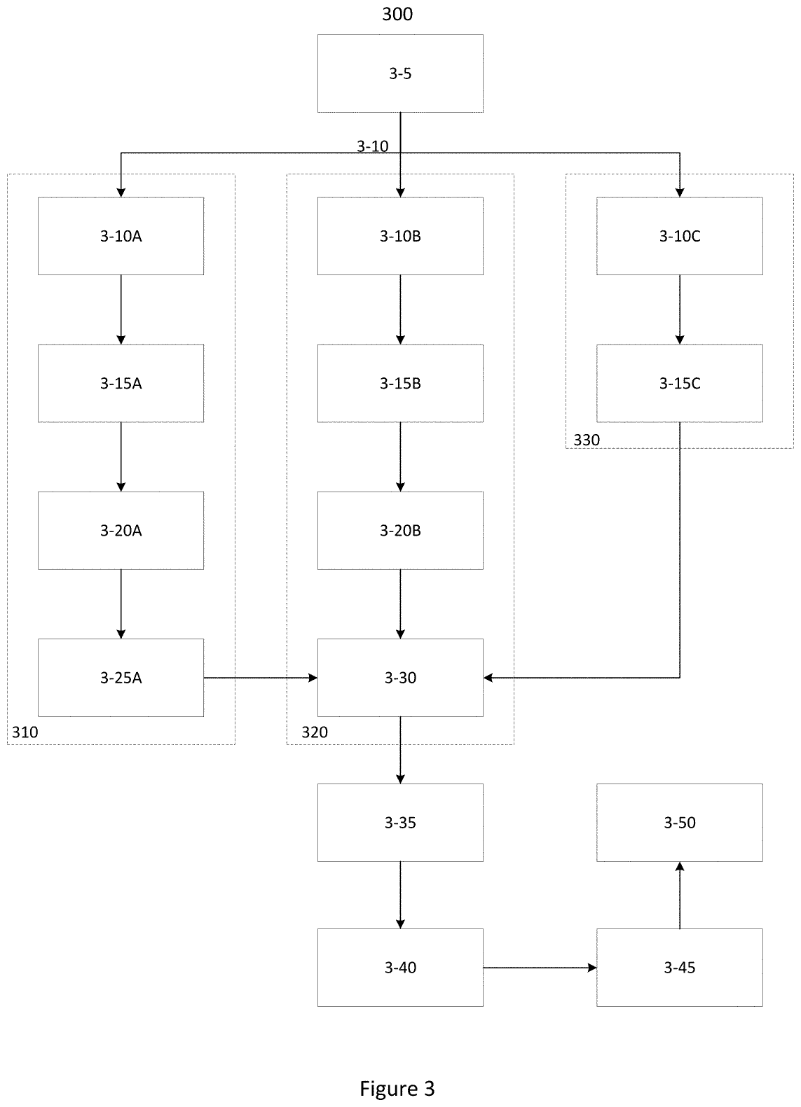

With reference to FIG. 3, a method 300 for executing a work order and corresponding work plan to maintain and/or repair and/or otherwise attend to a task subject is described. The method 300 represents a workflow for attending to the task subject.

The method 300 commences at 3-5, where the work order generated by the first electronic device 1-10 in operation 200 is received by the workflow server 1-20.

Next, at 3-10, the workflow server 1-20 commences a number of sub-workflows including a resourcing sub-workflow 3-10, a location analysis sub-workflow 3-20, and a prioritising sub-workflow 3-30. In the preferred embodiment, each of the sub-workflow 3-10, 3-20, 3-30 are performed in parallel.

The resourcing sub-workflow 3-10 includes steps 3-10A to 3-25A as follows.

At 3-10A, the workflow server 1-20 identifies and retrieves from the workflow database 1-30 an appropriate task description based on the information provided in the work order. The task description is a piece of reference material setting out the methods, tasks/sub-tasks, resources, skills, risk assessment, and other information necessary to safely and properly execute the work order, for example the maintenance or repair of the task subject. Task descriptions may be of varying levels of specificity and detail. For example, a task description may be simply specific to a specific task, or to a specific task in a specific location, or to a specific task in a specific environment, and the like.

At 3-15A, the workflow server 1-20 identifies from the task description the resources necessary to safely and properly carry out the task.

At 3-20A, the workflow server 1-20 identifies from the task description the makeup and composition of a work crew that is sufficient in terms of numbers, skills, and experiences to safely and properly carry out the tasks are identified from the task description.

At 3-25A, SWMS relevant to the task and to the operation of any resources required for the task are identified.

Once the above steps 3-10A to 3-25A are complete, the task description, required resources, required work crew makeup and composition, and relevant SWMS are made available for future analysis and processing by the workflow server 1-20, as will be described in greater detail below.

The location analysis sub-workflow 3-20 includes step 3-10B to 3-20B as follows:

At 3-10B, the workflow server 1-20 identifies a location of the task subject from the work order, for example using the location information included in the original issue log (see 2-10).

At 3-15B, the workflow server 1-20 identifies and retrieves from the database 1-30, and/or any other 3^{rd} party source of information, an appropriate location description. The location description is a piece of reference material providing information about the location, such as current and forecasted weather conditions, weather patterns, seasonal patterns, weather-associated risks, geographical features and associated risks (e.g. pits, sinkholes, ground conductivity, crevasses, etc.), indigenous significance, environmental constraints and sensitivities, and the like.

At 3-20B, the location description(s) is made available for future analysis and processing by the workflow server 1-20, as will be described in greater detail below.

The prioritising sub-workflow 3-30 includes steps 3-10C and 3-15C as follows:

At 3-10C, the workflow server 1-20 determines the priority of the work order from the original issue log.

At 3-15C, the workflow server 1-20 identifies and retrieves from the database 1-30 an appropriate priority description for the determined priority of the work order. The priority description is a piece of reference material stipulating any additional considerations, actions, communications, and the like that need to be taken for a given priority status of a work order.

At 3-20C, the priority description is made available for future analysis and processing by the workflow server 1-20, as will be described below.

Returning now to the parent workflow of method 3-00, at 3-30 the task description, location description, priority description, and all corresponding information contained in these descriptions, are analysed by the workflow server 1-20 to generate a work plan.

In the preferred embodiment, as part of the analysis performed by the workflow server 1-20, one or more of the storage centre 1-50 and vehicle centre 1-80 are accessed to ascertain and confirm the availability of resources, equipment, and vehicles. Additionally, based on the task description, a search for suitable personnel to comprise a work crew with the required skills and experience to perform the task is performed.

At 3-35, the workflow server 1-20 generates a work plan. The work plan details what resources are required, where the resources are to be retrieved from and when, the route to take to collect the resources and to get to the location of the task subject (the details of the route to take can include information on areas of indigenous significance that need to be travelled through), the personnel for the work crew, a schedule/timeline for the task, and the like. Additionally, the workflow server 1-20 transmits to a plural number of second electronic devices 1-60, which in this case is to be understood as each in the possession of the personnel who will be comprising the work crew (amongst other personnel), the work plan and an electronic message/notification to inform the respective personnel that they have been added to a work crew. Each member of the work crew therefore has access to details of the task to be performed, locations, timings, schedules, coordinating instructions, and the like, through their respective second electronic devices 1-60.

At 3-40, the work plan is executed. Execution of the work plan includes the forming of the work crew, the pickup of all necessary resources and vehicles, travel to the task subject location in accordance with a navigation route of the work plan, and performance of the task. The execution of the work plan, performance of the task, operation of equipment, and any other activity required to be performed as part of the work plan, are in accordance and reference with the procedures set out by the work plan, and further in accordance and reference with the relevant SWMS also set out by the work plan. All such information/instruction/guidance is available on each second electronic device 1-60 of each member of the work crew by way of the work plan received thereby from the work flow server 1-20 at 3-30. Accordingly, the performance of the task is in accordance with best practice at the time, and in accordance with all mandated/recommended safety procedures. Additionally, a minimum standard of safety and competence is ensured by virtue of simply following the issued work plan.

At 3-45, upon completion of all necessary tasks, the second electronic device 1-60 in a preferred embodiment is configured and operated by the software application and user to conduct a Post Action Review (PAR) of the work plan just executed. The PAR includes feedback on what went well in the execution of the work plan, and more importantly, what did not go well or was poorly managed/coordinated and whether there were any safety breaches or incidents. The PAR includes feedback on additional information such as indigenous mores associated with the location or the route taken to reach the location.

At 3-50, the logged task subject (i.e. the subject of the original issue log), corresponding work order, and corresponding work plan are recorded in the workflow database 1-30 as historical information. This historical information may be used by the workflow server 1-20 to schedule periodic and/or pre-emptive maintenance.

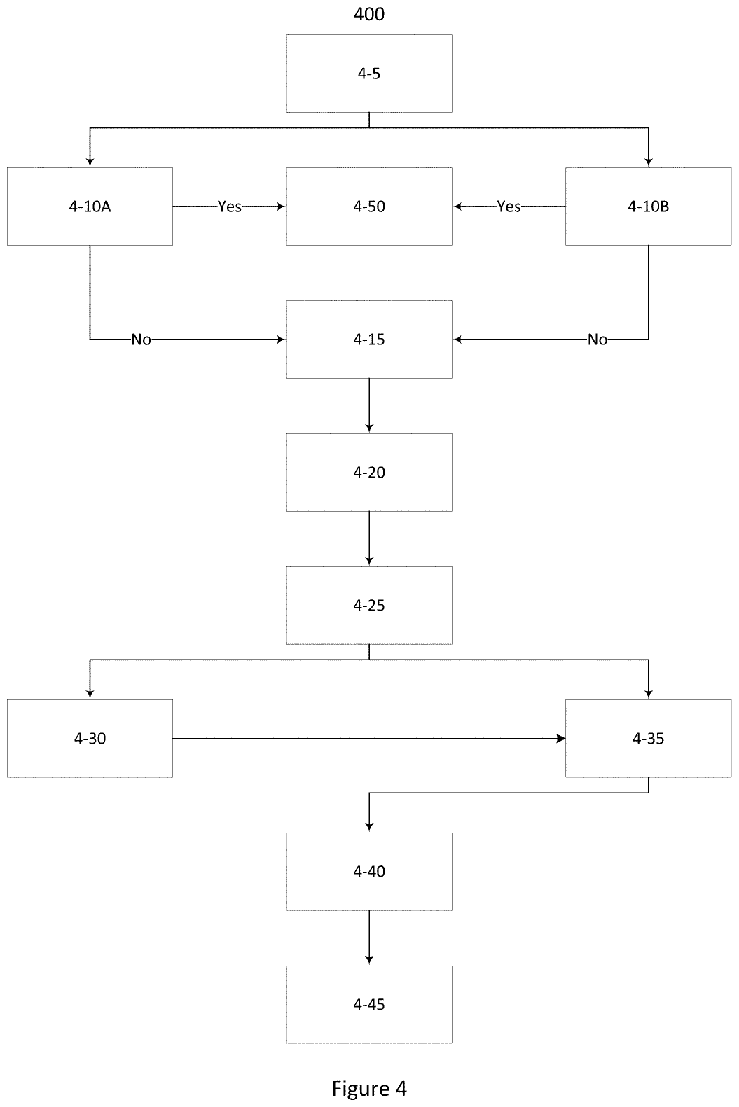

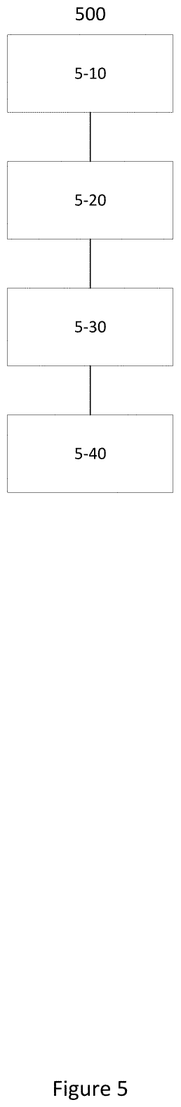

With reference now to FIG. 4, a method 400 for reviewing and updating reference material in the workflow database 1-30 is described.

At 4-5 a PAR is received by the workflow server 1-20.

At 4-10A and 4-10B, the PAR is analysed by the workflow server 1-20 to determine if the procedure stipulated by the work plan and the SWMS referenced by the work plan were adequate.

At 4-50, if both the procedures and SWMS employed during execution of the work plan were adequate, no further action is taken. Conversely, if either of the procedure and SWMS were in some way inadequate, the second electronic device 1-60 extracts from the PAR (at 4-15) an explanation, recommendation, and/or comment from by the second work crew 1-55 in regards to how the procedures/SWMS were inadequate.

At 4-20, the extracted explanation/recommendation/comment is sent to a reviewer. In the preferred embodiment, the reviewer is in possession of an electronic device such as one of electronic devices 1-10 and 1-60, and receives the explanation/recommendation/comment thereon.

At 4-25, the identified procedures and SWMS are reviewed, and if necessary, an investigation into how the inadequacies can be resolved is conducted. The outcomes of the review/investigation inform any necessary revisions.

At 4-30, the relevant procedures and documentation are revised as necessary, in consideration of the outcomes of the review/investigation.

At 4-35, the workflow server 1-20 identifies other procedures, SWMS, reference material, and the like which may share the same inadequacies, and revises them in the same way.

At 4-40, the revised procedures, SWMS, reference material, and the like are field tested.

At 4-45, pending a successful field test, the workflow server 1-20 formally adopts and accepts the revised procedures, SWMS, reference material, and the like and makes them available for use by the system 100.

With reference now to FIG. 5, a method 500 for pre-empting a task and/or scheduling a periodic task is described.

At 5-10, the workflow server 1-20 analyses a historical record of logged task subjects (e.g. issue logs) and performs a pattern identification process on the historical record. The pattern identification process seeks to identify commonalities between logged tasks, such as (but not limited to):
tasks that have been conducted in the same approximate location
tasks of the same nature
tasks conducted at the same approximate time/date/season
tasks conducted following various events (e.g. weather events)
tasks conducted following a certain duration following a previous similar task on the same task subject at around the same time

At 5-20, any identified patterns are used to extrapolate pre-emptive or periodic maintenance.

At 5-30, the pre-emptive/periodic maintenance tasks are scheduled, and the workflow server 1-20 pre-generates a work plan for each of these pre-emptive/periodic maintenance tasks.

At 5-40, the pre-generated work plan, or at least a part thereof, is notified to personnel comprising the work crew specified in the pre-generated work plan. In this manner, the personnel are advised in advance of upcoming tasks.

### Advantages

The present invention provides a system and method for electronically identifying and logging a task subject, such as a fault or hazard that requires attention. Once logged, the system and method of the present invention commences a workflow to have the task subject attended to, which workflow includes, for example, the generation of a work order, the execution of a work order, the generation of a work plan, and the execution of the work plan. As this workflow is electronically generated, recorded, and executed, tracking thereof is facilitated. Additionally, issues of information loss, miscommunication, destruction, and the like prevalent in manual systems and/or paper-based systems are mitigated.

The present invention further provides a system and method that allows for the ready/convenient, remote access of reference materials required for the safe and proper performance of tasks and sub-tasks. This ensures that work crews have readily available to them all necessary information. Performance of tasks and sub-tasks can therefore be conducted with the advantage of having immediate reference to the reference material if necessary. In this manner, a minimum standard of safety and competence can be ensured by virtue of simply following the issued work plan.

Still further, the present invention provides a system and method that allows for feedback from executed work plans to be reviewed, and reference material stored in the work flow database 1-30 updated and revised as necessary. In this manner, best practices in terms of safety, productivity, and efficiency are continually improved.

Still further, the present invention provides a system and method that keeps a record of all historical logged task subjects, work orders, and work plans. Analysis of such historical information allows for the scheduling of regular maintenance tasks as well as pre-emptive maintenance tasks. In this manner, potential faults, hazards and other issues are attended to before they become actual faults, hazards, and issues, whereby safety and productivity are increased, and costs reduced.

Still further, the present invention provides a system and method that allows for information that relates to indigenous culture or knowledge related to a location to be logged. In this manner, indigenous information can be safely catalogued, and work can be conducted in a culturally appropriate way.

### Variations

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. An issue tracking and rectification system including
a workflow server;
a workflow database connected to the workflow server; and
a first mobile electronic device connected to the workflow server via a network,
wherein the first electronic device is configured to capture an image of a task subject, determine a location of the task subject and generate an issue log using the image and location, and further wherein the first electronic device is configured to generate a work order from the issue log and transmit the work order to the workflow server over the network, whereby the workflow server commences a workflow to attend to the task subject.

2. An issue tracking and rectification system as claimed in claim 1, wherein the workflow server identifies and retrieves from the workflow database a task description for the work order, the task description setting out at least the resources, required for the safe and proper execution of the work order.

3. An issue tracking and rectification system as claimed in claim 2, wherein the task description further sets out one or more of the method, tasks, sub-tasks, and skills required for the safe and proper execution of the work order.

4. An issue tracking and rectification system as claimed in claim 2, wherein the workflow server determines from the task description a list of resources and personnel skills and experiences required for the execution of the work order.

5. An issue tracking and rectification system as claimed in claim 2, wherein the workflow server retrieves from the workflow database and/or other external databases a location description, the location description setting out one or more characteristics of the task subject location.

6. An issue tracking and rectification system as claimed in claim 5, wherein the first electronic device is configured to transmit one or more characteristics to the workflow server over the network to be included in the location description.

7. An issue tracking and rectification system as claimed in claim 5, wherein the workflow server retrieves from the workflow database a priority description, the priority description stipulating additional considerations, constraints, communications and other actions to be taken for a given priority status of a work order.

8. An issue tracking and rectification system as claimed in claim 7, wherein the workflow server analyses analyzes each of the task description, location description, and priority description, and generates a work plan therefrom.

9. An issue tracking and rectification system as claimed in claim 8, wherein the analysis performed by the workflow server includes a confirmation with a storage centre to ascertain and confirm availability of resources at the storage centre.

10. An issue tracking and rectification system as claimed in claim 8, wherein the analysis performed by the workflow server includes a search for personnel with the required skills and experience to comprise a work crew to attend to the tasks required by the work order.

11. An issue tracking and rectification system as claimed in claim 1, wherein the workflow server generates a work plan, the work plan detailing one or more of required resources, locations of required resources, route to collect required resources, personnel comprising work crew, tasks to be performed, and schedule/timing of tasks.

12. An issue tracking and rectification system as claimed in claim 10, wherein the workflow server transmits the work plan to a plurality of second electronic devices, each of the plurality of second electronic devices being operated by personnel comprising the work crew.

13. An issue tracking and rectification system as claimed in claim 12, wherein each of the plurality of second electronic devices configured to transmit one or more characteristics to the workflow server over the network to be included in the location description.

14. An issue tracking and rectification method including
a first electronic device capturing an image of a task subject,
the first electronic device determining a location of the task subject,
the first electronic device generating an issue log from the captured image and the determined location,
the first electronic device generating a work order from the issue log, and
the first electronic device transmitting the work order to a workflow server over a network,
wherein upon receipt of the work order, the workflow server commences a workflow to attend to the task subject.

15. An issue tracking and rectification method as claimed in claim 14, further including the workflow server identifying and retrieving from the workflow database a task description for the work order, the task description setting out at least resources, required for safe and proper execution of the work order.

16. An issue tracking and rectification method as claimed in claim 15, wherein the task description further sets out one or more of the method, tasks, sub-tasks, and skills required for the safe and proper execution of the work order.

17. An issue tracking and rectification method as claimed in claim 15, wherein the workflow server determines from the task description a list of resources and personnel skills and experiences required for the execution of the work order.

18. An issue tracking and rectification method as claimed in claim 14, wherein the workflow server retrieves from the workflow database and/or other external databases a location description, the location description setting out one or more characteristics of the task subject location.

19. An issue tracking and rectification method as claimed in claim 18, further including the first electronic device transmitting one or more characteristics to the workflow server over the network to be included in the location description.

20. An issue tracking and rectification method as claimed in claim 14, further including the workflow server generating a work plan, the work plan detailing one or more of required resources, locations of required resources, route to collect required resources, personnel comprising work crew, tasks to be performed, and schedule/timing of tasks.
